(19) United States
(12) Patent Application Publication
(10) Pub. No.: US 2004/0023713 A1
(43) Pub. Date: Feb. 5, 2004

(54) Gaming device having a paytable with direct control over distribution of outcomes

(76) Inventors: Bryan D. Wolf, Reno, NV (US); Aaron T. Jones, Reno, NV (US)

Correspondence Address: BELL, BOYD & LLOYD LLC, P. O. BOX 1135, CHICAGO, IL, 60690-1135, US

(21) Appl. No.: 10/210,452

(22) Filed: Jul. 31, 2002

(51) Int. Cl. G07F 17/34

(52) U.S. Cl. 463/20

(57) ABSTRACT

A gaming device including a paytable enabling control over the distribution of outcomes. The paytable is designed by classifying all possible results of the gaming device into outcome types. The results are then numbered within the outcome types and assigned numerical ranges. In one example, a processor, in an attempt to produce a desired outcome, draws a number associated with a result and locates the result within a table containing the desired outcome's numerical range. The processor then produces the result and awards a player for the outcome.

### BACKGROUND OF THE INVENTION

Gaming devices are generally known. Most gaming devices are games of chance whereby a player operates the gaming device hoping to achieve a winning result and thus a winning outcome from several different types of results. Outcomes include, for example, jackpots, high wins, moderate wins, low wins and losses Each outcome can be produced in a variety of ways.

In one example, a slot machine game having three reels may award five credits to a player receiving three different types of “BAR” symbols. Each reel contains at least one of the three different “BAR” symbols, including “BAR”, “DOUBLE BAR”, and “TRIPLE BAR.” In one result, the player receives a “DOUBLE BAR”, “BAR” and “TRIPLE BAR” on the first, second and third reels, respectively. In another result, the player receives “TRIPLE BAR”, “DOUBLE BAR” and “BAR” on the first, second and third reels, respectively. Thus, there is more than one result which corresponds to the same outcome; that is, the player receiving five credits.

The outcome or amount a player receives for a particular result in a game is typically determined by a paytable. The paytable classifies the results of the games and assigns an outcome or award amount, if any, to each result. Conventionally, the probability of each outcome is determined by the number of ways that the outcome can be or is randomly produced. For instance, if there are two possible outcomes, thirty ways to produce a first of those outcomes and seventy ways to produce the second of those outcomes, there is a 30% chance of obtaining the first outcome and a 70% chance obtaining the second outcome. A paytable percentage is computed by adding the products of each outcome's probability and award amount. The probability that a person will win, lose or break even during any given game will then be known.

Current methods of designing paytables are limited in their control of gaming device payouts. For example, current gaming devices have different payout schedules. Certain games provide higher percentage returns than others. For this reason, certain games are more popular than others.

Certain players are attracted to gaming devices having paytables with chances of very high wins. Others are attracted to gaming devices having paytables which provide a high frequency of low or moderate wins. Designing a paytable in a gaming device that provides both of these types of payouts, however, is difficult and time-consuming.

In addition, the paytables of certain games make them incapable of being associated with progressive jackpots. The probability of achieving the winning result in these games is too high to correlate to, for instance, a jackpot such as a million dollar prize. Progressive games are also limited in that only a particular type of gaming device can be operated in order to win the progressive jackpot.

Thus, it is desirable to provide an improved gaming device including a paytable which addresses the above-mentioned disadvantages and a method for creating such paytable.

### SUMMARY OF THE INVENTION

The present invention provides a gaming device including a paytable which enables the gaming device to have direct control over the distribution of outcomes. The present invention also provides a method for creating such a paytable. The method generally includes calculating the number of results a gaming device produces, classifying the results into sets of results, and assigning an outcome or award value, if any, to each set of results. The method further includes numbering each result in each set of results such that each result has a specific associated number and the sets of results each have number ranges. All of the sets also have a total number range.

When the paytable is used in the gaming device, a number is randomly selected within an outcome number range. The number corresponds to a specific result. The result is produced by the gaming device. In one example, a slot machine game may have 50 results which provide 0 credits. The set of results in which the outcome is 0 credits is numbered from 1 to 50. There are 25 results that pay 1 credit. These results are numbered from 51 to 75. In one example, the gaming device randomly determines that 1 credit will be awarded for the play of the game. Based on this determination, the gaming device draws a random number from the range of 51 to 75, which is the number range associated with 1 credit. In this example, the number drawn is 63. The gaming device searches within memory stored in its processor to locate the result which is associated with that number. The gaming device then produces and display that result to the player and provides the award of one credit to the player as the outcome.

In an alternative embodiment, when the gaming device chooses to award 1 credit, the gaming device randomly selects a number from 1 to 25, or the number of results that provide 1 credit. The gaming device then adds this number to the first number in the appropriate range. In one example, the number drawn is 7. The corresponding number is 57. The gaming device locates the result associated with that number within its memory. The gaming device then produces and displays that result to the player and awards 1 credit to the player as the outcome.

It is therefore an advantage of the present invention to provide a gaming device enabling direct control over both the distribution of outcomes.

Another advantage of the present invention is to provide a paytable in a gaming device making the gaming device suitable for a progressive jackpot.

Another advantage of the present invention is to provide a method enabling the duplication of existing paytables.

Another advantage of the present invention is to provide a method that creates a paytable providing different types of payouts in a gaming device.

Another advantage of the present invention is to provide a method of creating a paytable that enables disparate games to be associated with the same progressive jackpot.

Other objects, features and advantages of the invention will be apparent from the following detailed disclosure, taken in conjunction with the accompanying sheets of drawings, wherein like numerals refer to like parts, elements, components, steps and processes.

### BRIEF DESCRIPTION OF THE FIGURES

FIGS. 1A and 1B are perspective views of alternate embodiments of the gaming device of the present invention.

FIG. 2 is a schematic block diagram of the electronic configuration of one embodiment of the gaming device of the present invention.

FIG. 3 is a flow diagram of one known method of designing a paytable.

FIG. 4 is a flow diagram of one known method of using a paytable.

FIG. 5 is a flow diagram of a method for designing a paytable in one embodiment of the present invention.

FIG. 6 is a flow diagram of a method for using a paytable of one embodiment of the present invention.

FIG. 7 is a table of outcomes for an example keno game in one example of the current method of setting a paytable.

FIG. 8 is a table of probabilities for the keno game of FIG. 7.

FIG. 9 is a table of payouts for the keno game of FIG. 7.

FIG. 10 is a table of the paytable percentage for the keno game of FIG. 7.

FIG. 11 is a distribution table for the keno game of FIG. 7.

FIG. 12 is a paytable designed for an example keno game in one embodiment of the present invention.

FIG. 13 is a distribution table for the keno game of FIG. 12.

FIG. 14 is a table of outcomes for a slot machine game in one embodiment of the present invention.

FIG. 15 is a table of probabilities for the slot machine game of FIG. 14.

FIG. 16 is a distribution table for the slot machine game of FIG. 14.

FIG. 17 is a table of outcome data for the slot machine game of FIG. 14.

FIG. 18 is a table of outcome data for the slot machine game of FIG. 14 in which results are grouped for each outcome.

FIG. 19 is a table of outcome data for the slot machine game of FIG. 14 in which results within outcome groups are numbered.

FIG. 20 is a table of outcome data for the slot machine game of FIG. 14 in which numerical ranges are assigned to the outcome groups.

FIG. 21 is a table of outcome data for the slot machine game of FIG. 14.

FIG. 22 is a table of outcomes for an example video poker game in one embodiment of the present invention.

FIG. 23 is a distribution table for the video poker game of FIG. 22.

FIG. 24 is a hand notation table for the video poker game of FIG. 22.

FIG. 25 is a table of results for the video poker game of FIG. 22.

FIG. 26 is a table of arbitrary values for the video poker game of FIG. 22.

FIG. 27 is a paytable for the video poker game of FIG. 22.

FIG. 28 is a table of ranges for the video poker game of FIG. 22.

FIG. 29 is an index for a checkers game in an embodiment of the present invention.

FIG. 30 is a front elevation view of a display device displaying a checkers game in an embodiment of the present invention.

### DETAILED DESCRIPTION OF THE INVENTION

### Gaming Device and Electronics

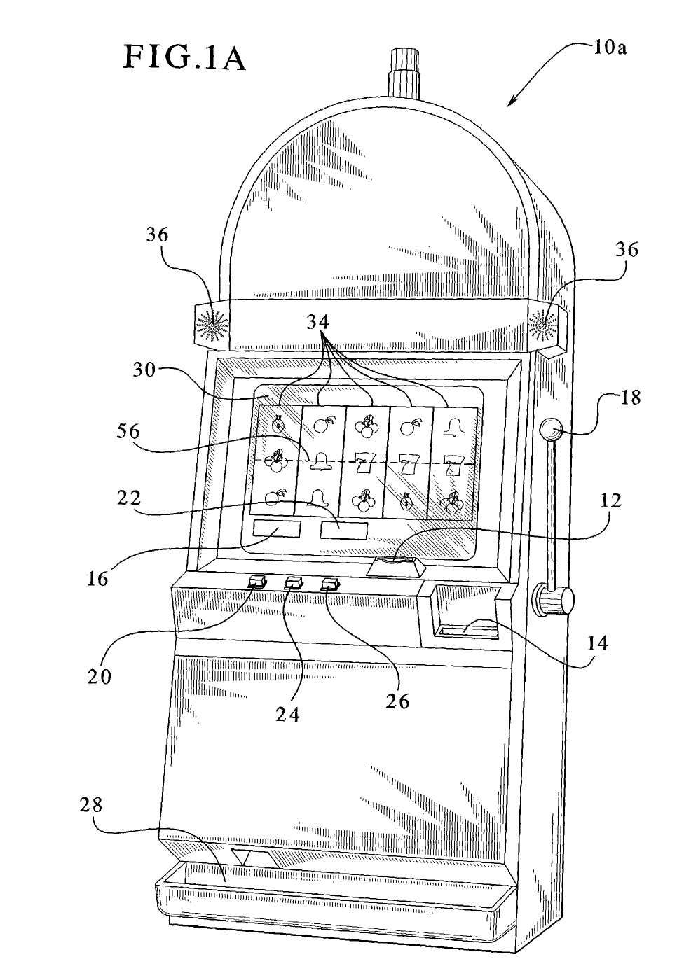

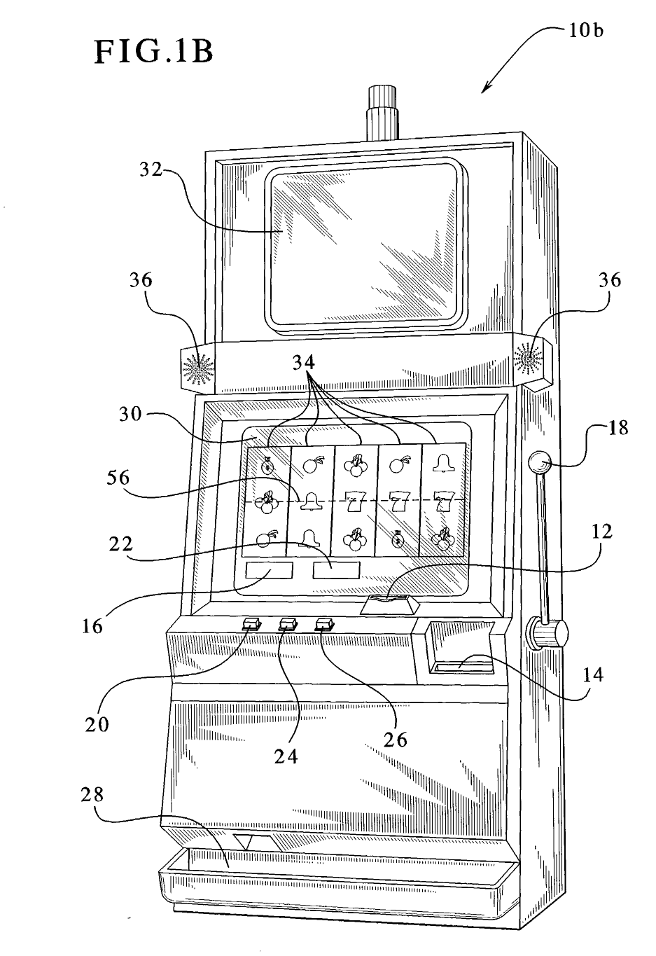

Referring now to the drawings, and in particular to FIGS. 1A and 1B, gaming device 10a and gaming device 10b illustrate two possible cabinet styles and display arrangements and are collectively referred to herein as gaming device 10. The present invention includes any game being a stand alone game or a bonus or secondary game that coordinates with a base game. The player can operate the gaming device while standing or sitting. Gaming device 10 also includes being a pub-style or table-top game (not shown), which a player operates while sitting.

In a stand alone or a bonus embodiment, the gaming device 10 includes monetary input devices. FIGS. 1A and 1B illustrate a coin slot 12 for coins or tokens and/or a payment acceptor 14 for cash money. The payment acceptor 14 also includes other devices for accepting payment, such as readers or validators for credit cards, debit cards or smart cards, tickets, notes, etc. When a player inserts money in gaming device 10, a number of credits corresponding to the amount deposited is shown in a credit display 16. After depositing the appropriate amount of money, a player can begin the game by pulling arm 18 or pushing play button 20. Play button 20 can be any play activator used by the player which starts any game or sequence of events in the gaming device.

As shown in FIGS. 1A and 1B, gaming device 10 also includes a bet display 22 and a bet one button 24. The player places a bet by pushing the bet one button 24. The player can increase the bet by one credit each time the player pushes the bet one button 24. When the player pushes the bet one button 24, the number of credits shown in the credit display 16 decreases by one, and the number of credits shown in the bet display 22 increases by one. A player may cash out by pushing a cash out button 26 to receive coins or tokens in the coin payout tray 28 or other forms of payment, such as an amount printed on a ticket or credited to a credit card, debit card or smart card.

Gaming device 10 also includes one or more display devices. The embodiment shown in FIG. 1A includes a central display device 30, and the alternative embodiment shown in FIG. 1B includes a central display device 30 as well as an upper display device 32. The display devices display any visual representation or exhibition, including but not limited to movement of physical objects such as mechanical reels and wheels, dynamic lighting and video images. The display device includes any viewing surface such as glass, a video monitor or screen, a liquid crystal display or any other static or dynamic display mechanism. In a video poker, blackjack or other card gaming machine embodiment, the display device includes displaying one or more cards.

The slot machine base game of gaming device 10 preferably displays a plurality of reels 34 such as three to five reels 34 in mechanical or video form on one or more of the display devices. Each reel 34 displays a plurality of symbols or indicia such as bells, hearts, fruits, numbers, letters, bars or other images which preferably correspond to a theme associated with the gaming device 10. If the reels 34 are in video form, the display device displaying the video reels 34 is preferably a video monitor. Each base game, especially in the slot machine base game of the gaming device 10, includes speakers 36 for making sounds or playing music.

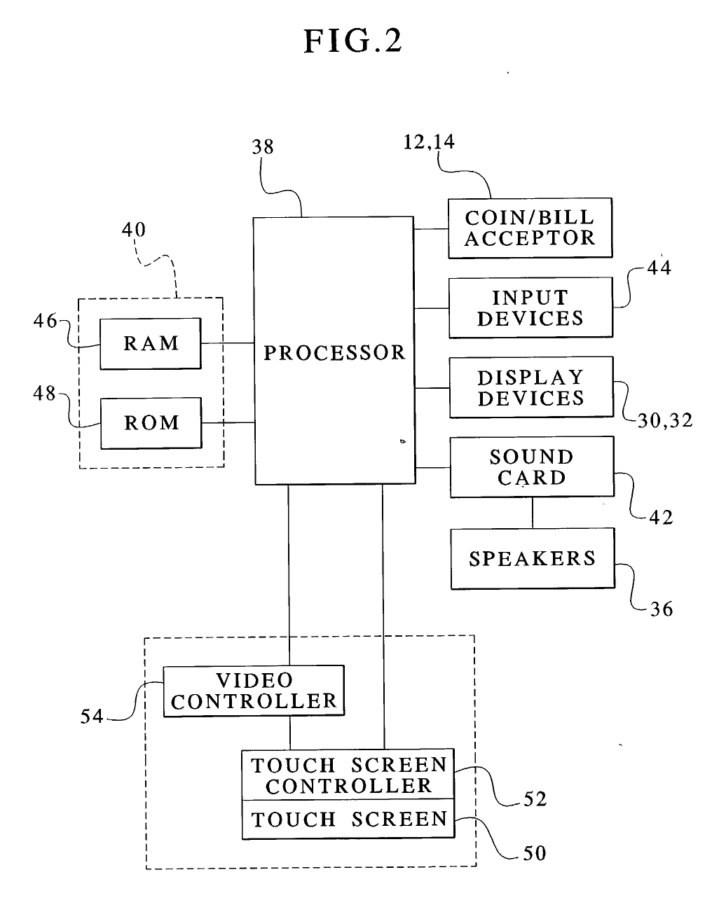

Referring now to FIG. 2, a general electronic configuration of the gaming device 10 for the stand alone and bonus embodiments described above preferably includes: a processor 38; a memory device 40 for storing program code or other data; a central display device 30; an upper display device 32; a sound card 42; a plurality of speakers 36; and one or more input devices 44. The processor 38 is preferably a microprocessor or microcontroller-based platform which is capable of displaying images, symbols and other indicia such as images of people, characters, places, things and faces of cards. The memory device 40 includes random access memory (RAM) 46 for storing event data or other data generated or used during a particular game. The memory device 40 also includes read only memory (ROM) 48 for storing program code, which controls the gaming device 10 so that it plays a particular game in accordance with applicable game rules and paytables.

As illustrated in FIG. 2, the player preferably uses the input devices 44 to input signals into gaming device 10. In the slot machine base game, the input devices 44 include the pull arm 18, play button 20, the bet one button 24 and the cash out button 26. A touch screen 50 and touch screen controller 52 are connected to a video controller 54 and processor 38. The terms “computer” or “controller” are used herein to refer collectively to the processor 38, the memory device 40, the sound card 42, the touch screen controller and the video controller 54.

In certain instances, it is preferable to use a touch screen 50 and an associated touch screen controller 52 instead of a conventional video monitor display device. The touch screen enables a player to input decisions into the gaming device 10 by sending a discrete signal based on the area of the touch screen 50 that the player touches or presses. As further illustrated in FIG. 2, the processor 38 connects to the coin slot 12 or payment acceptor 14, whereby the processor 38 requires a player to deposit a certain amount of money in the gaming device to start the game.

It should be appreciated that although a processor 38 and memory device 40 are preferable implementations of the present invention, the present invention also includes being implemented via one or more application-specific integrated circuits (ASIC's), one or more hard-wired devices, or one or more mechanical devices (collectively and/or alternatively referred to herein as a “processor”). Furthermore, although the processor 38 and memory device 40 preferably reside in each gaming device 10 unit, the present invention includes providing some or all of their functions at a central location such as a network server for communication to a playing station such as over a local area network (LAN), wide area network (WAN), Internet connection, microwave link, and the like.

With reference to the slot machine base game of FIGS. 1A and 1B, to operate the gaming device 10, the player inserts the appropriate amount of tokens or money in the coin slot 12 or the payment acceptor 14 and then pulls the arm 18 or pushes the play button 20. The reels 34 then begin to spin. Eventually, the reels 34 come to a stop. As long as the player has credits remaining, the player can spin the reels 34 again. Depending upon where the reels 34 stop, the player may or may not win additional credits.

### One Known Method Of Designing A Paytable

The present invention provides an improved method for creating a paytable for a gaming device. The method enables a paytable to be set to meet certain objectives, such as a desired payout percentage, or a frequency of payout types (i.e., high, moderate and low). The method also allows for duplication of existing paytables. The advantages of the present invention will be better understood after an examination of certain known methods for designing and using paytables.

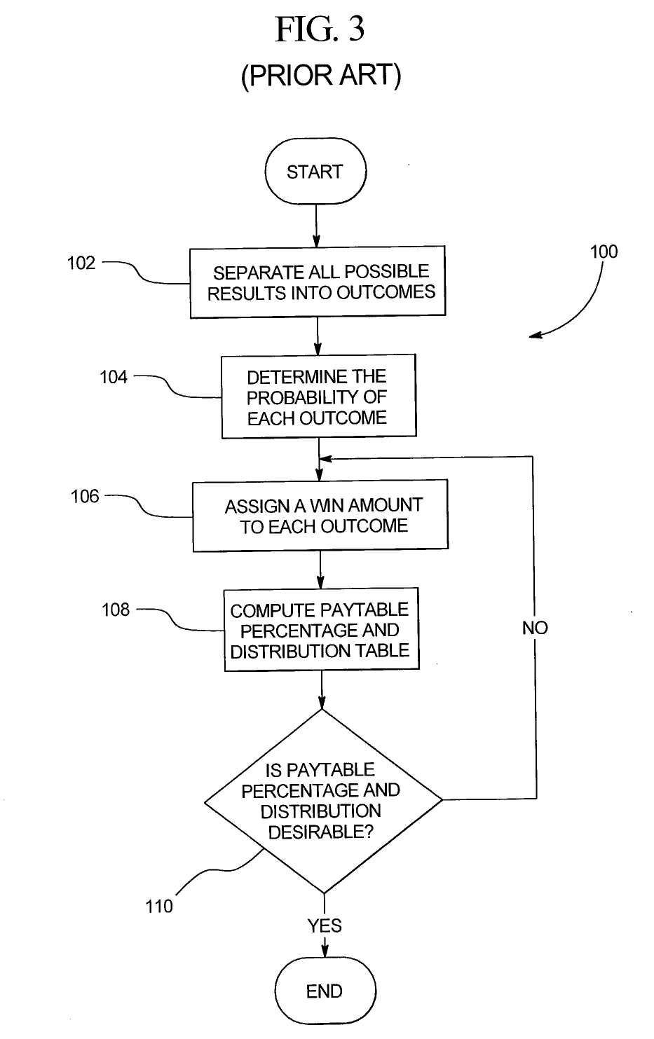

One known method of designing a paytable for a 10-spot keno game is illustrated in FIG. 3. In such a 10-spot keno game, the player marks 10 spots. The game then randomly draws 20 spots and awards the player based on how many of the player's marked spots were hit, or chosen.

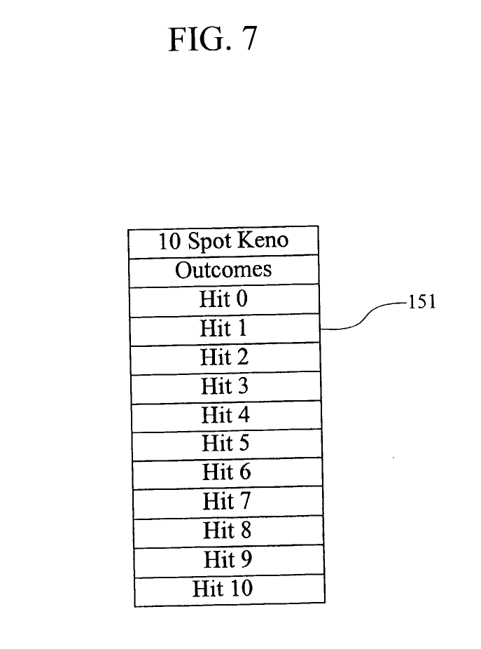

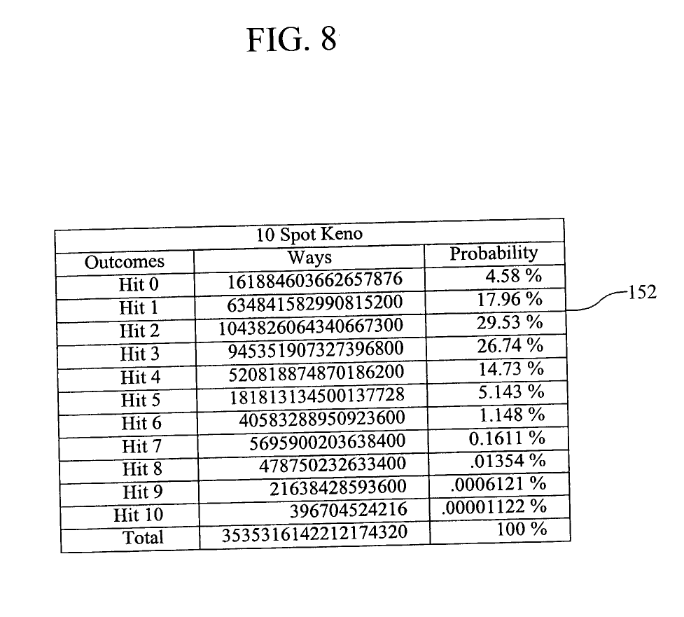

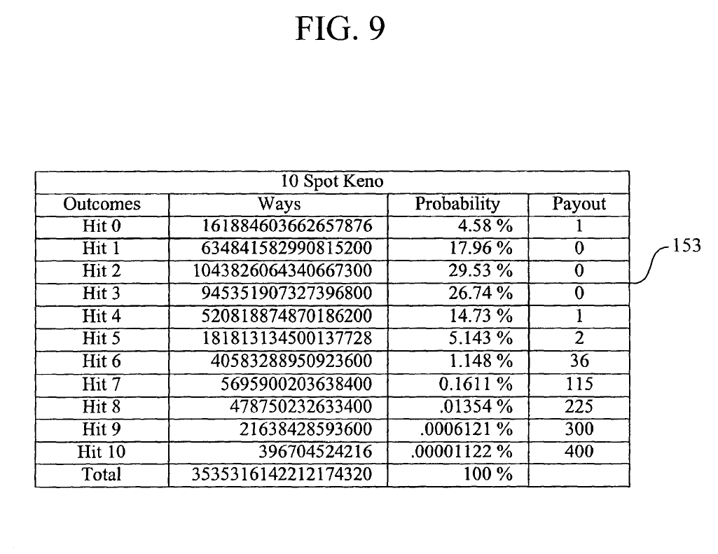

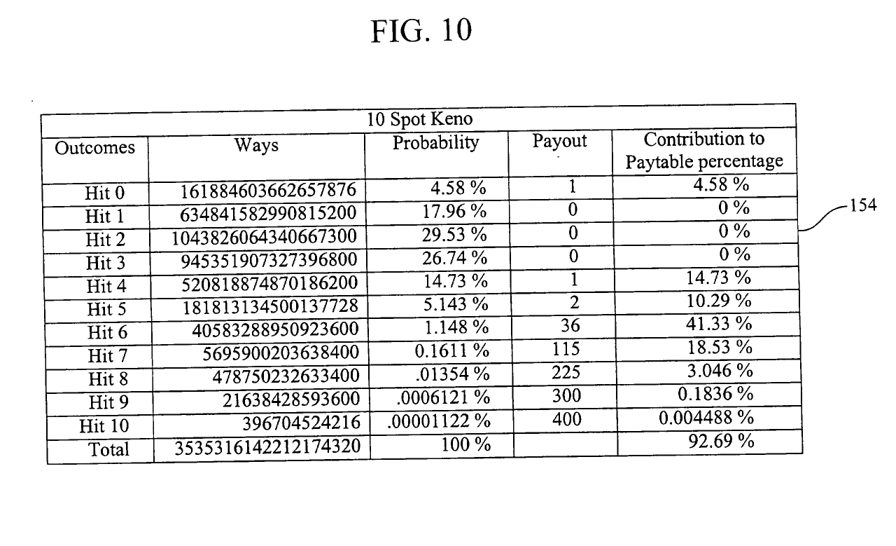

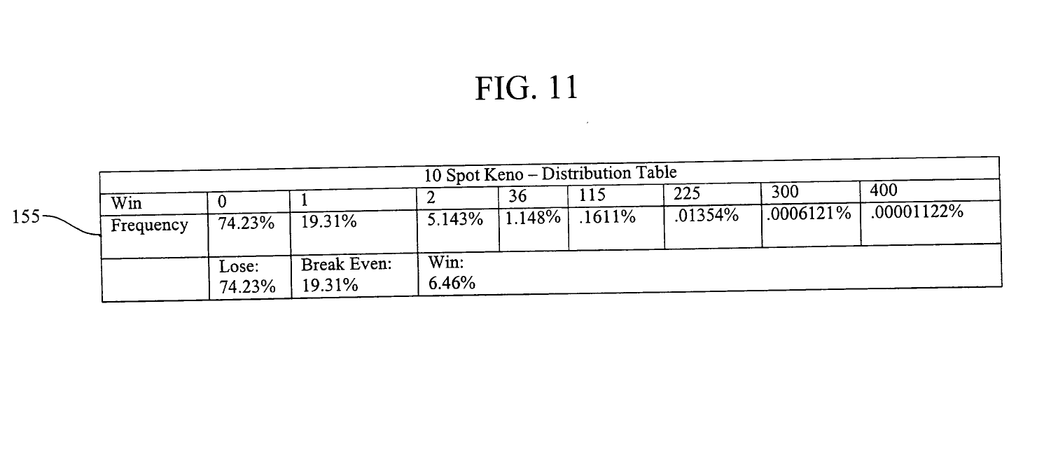

In the first step of the known method illustrated in FIG. 3, the game results are separated into outcomes as indicated by block 102. The outcomes for this game are shown in table 151 in FIG. 7. The probability of each outcome is calculated as indicated by block 104 and as shown in table 152 in FIG. 8. It should be understood that the probability of a given outcome is the number of results associated with that outcome, divided by the total number of results possible. A payout is assigned to each outcome as indicated by block 106 and as shown in a table 153 in FIG. 9. Next, a paytable percentage and distribution table are calculated as indicated in block 108. Each outcome's contribution to the paytable percentage is its probability multiplied by its payout. The sum of all the contributions is the paytable percentage, as shown in table 154 in FIG. 10. A distribution table 155 provided in FIG. 11, illustrates the probabilities of losing, neither winning or losing (i.e, breaking even) and winning. In this game, the total payout percentage is 92.69%; however, the player only wins 6.46% of the time. In the next step of the method, it is determined whether the paytable percentage and distribution are desirable as indicated by diamond 110. The paytable is then revised if undesirable.

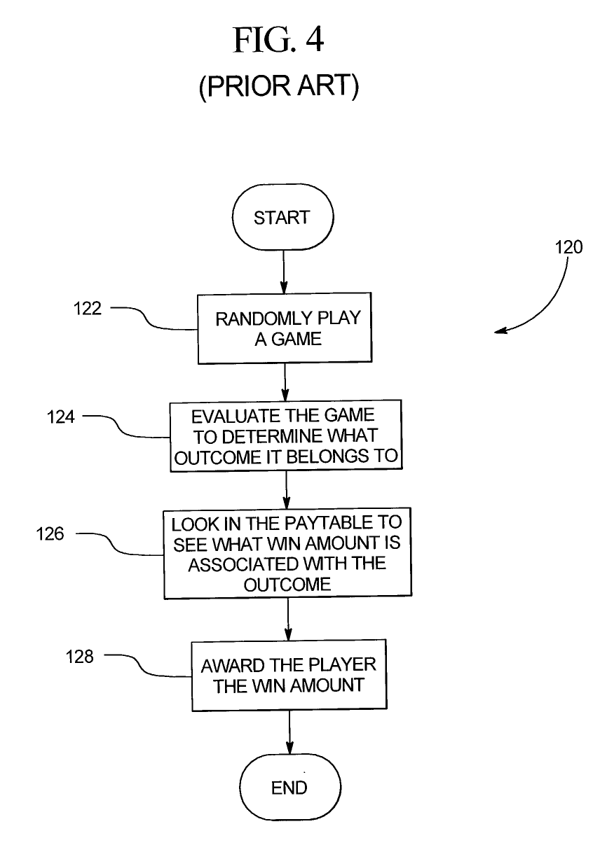

One is known method 120 of using the paytable in a gaming device is illustrated in FIG. 4. The gaming device randomly plays a game as indicated by block 122. The gaming device then determines which outcome has occurred as indicated by block 124. Next, the gaming device searches the paytable for the win amount associated with the outcome as indicated by block 126. The gaming device then awards the win amount to the player as indicated by block 128.

An example of this method is given now for 10-spot keno. In the keno game, the player marks 10 spots. The gaming device randomly draws 20 spots. Next, the game totals the number of spots drawn that coincided with spots marked by the player. The gaming device locates that number of hits in the paytable, as well as the winning amount, if any, that should be awarded to the player. Finally, the gaming device awards the appropriate win amount, if any, to the player.

### Method of Creating a Paytable

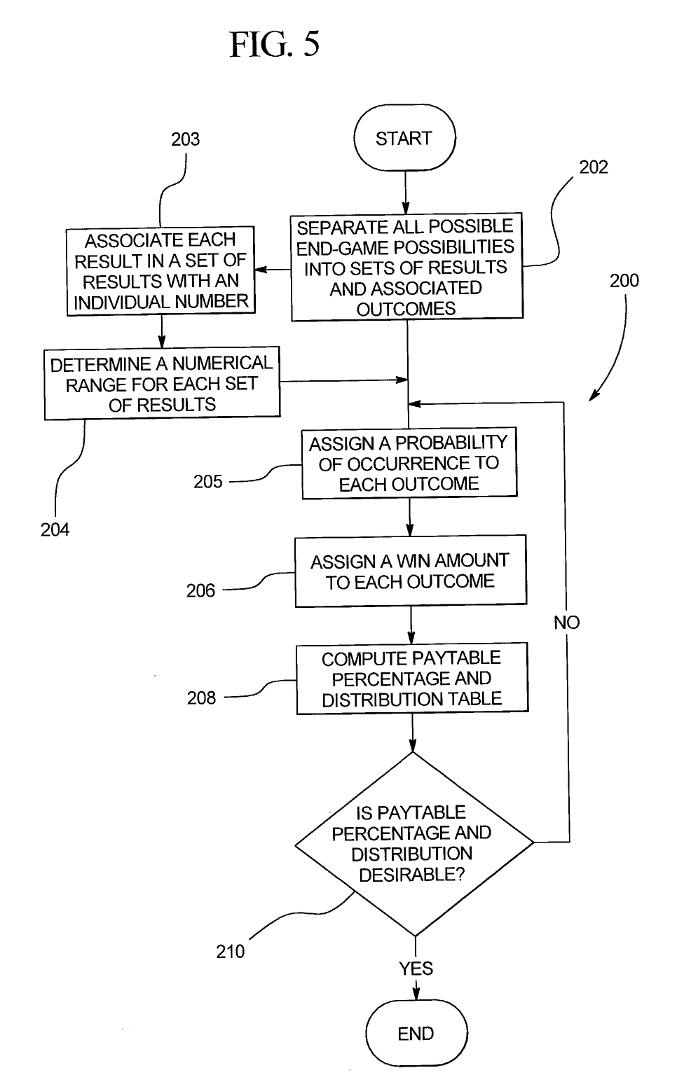

One embodiment of the method 200 of the present invention is illustrated in FIG. 5. In a first step, the game results are classified into sets of results and associated outcomes as indicated by block 202. Each result is then associated with an individual number as indicated by block 203. The number range for each set of results is then determined as indicated by block 204. A probability is assigned to each outcome as indicated by block 205 in a manner similar to that described earlier. A payout is then assigned to each outcome as indicated by block 206. The paytable is then calculated as indicated by block 208. The paytable percentage and distribution are then examined for desirability as indicated by diamond 210. If it is not desirable, the probabilities are reassigned.

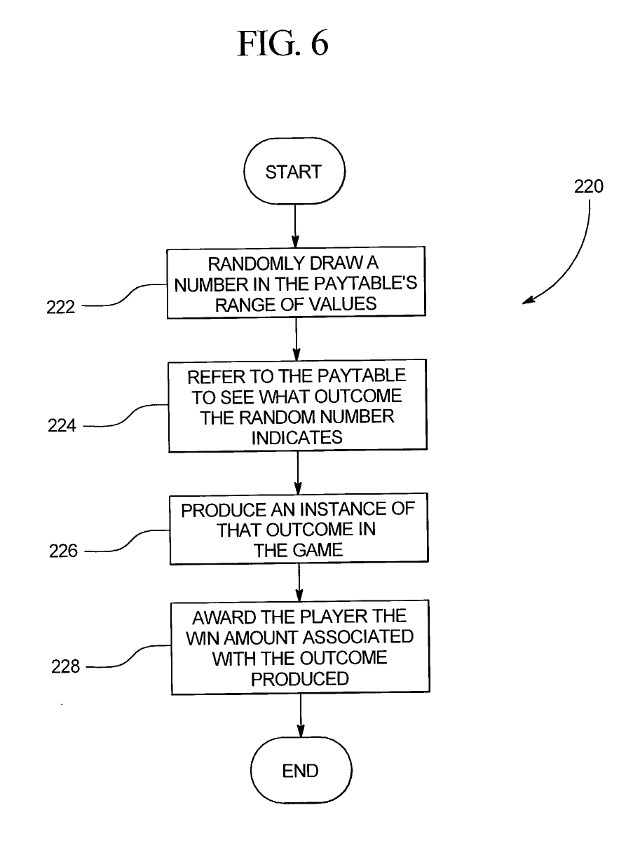

When the paytable is used in a gaming device, as shown in FIG. 6, the gaming device draws a number from the total range of values as indicated by block 222. The size of the range indicates the number of results possible for a given outcome. The gaming device searches the paytable to see which result, and therefore, outcome, the random number is associated with as indicated by block 224. The outcome is then produced for the player through the number-specific result as indicated by block 226. The player is then awarded for the result as indicated by block 228.

In an example of the use of this method for the keno game described above, the paytable is designed with three objectives: to increase wins uniformly with each hit; to enable the player to break even and win more frequently; and to make the top win for the game suitable for a 1,000,000-coin win or progressive jackpot.

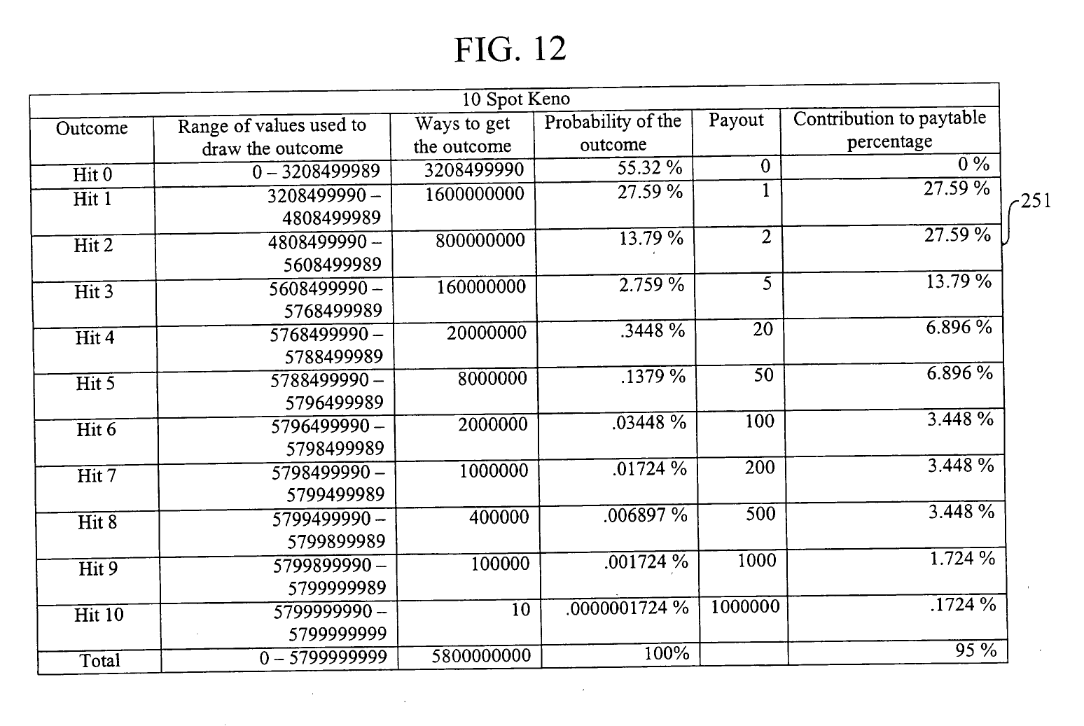

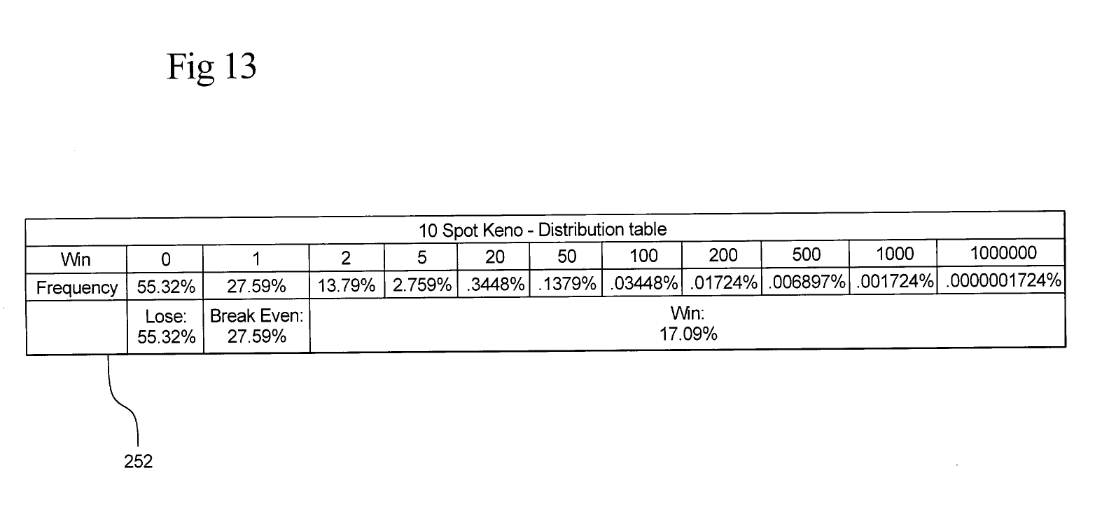

Based on the above objectives, a paytable may be designed as is shown in table 251 in FIG. 12. A corresponding distribution table 252 is provided in FIG. 13. The paytable meets all three objectives. The wins increase uniformly with each spot hit. The player loses approximately 55% of the time instead of 74%, and wins approximately 17% instead of 6%. In addition, the top win is suitable for a relatively large award or a progressive jackpot because the probability of obtaining such outcome is sufficiently low.

In the 10-Spot Keno example described above, the range would be 0 to 5799999999 (i.e., 5,800,000,000 possibilities). The gaming device would then draw a random number from 0 to 5799999999. Next, the gaming device examines the paytable to see what outcome is indicated in correlation to the number drawn. If the random number drawn is 5608499993, the outcome is a 3 spots hit. In the next step, the gaming device produces a 3-spots hit outcome. There are several methods of producing a desired game outcome, some of which are described below. In this example, the keno game produces a result by randomly choosing 3 of the player's 10 spots to use as hits, and randomly selecting 17 of the remaining 70 spots. Finally, the gaming device awards the player the amount for a 3 spots hit, which in this example is 5 credits.

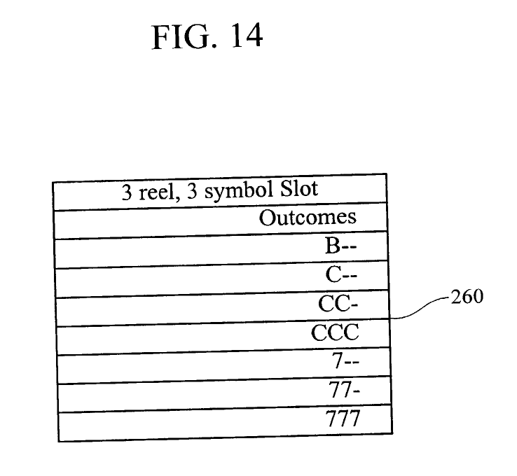

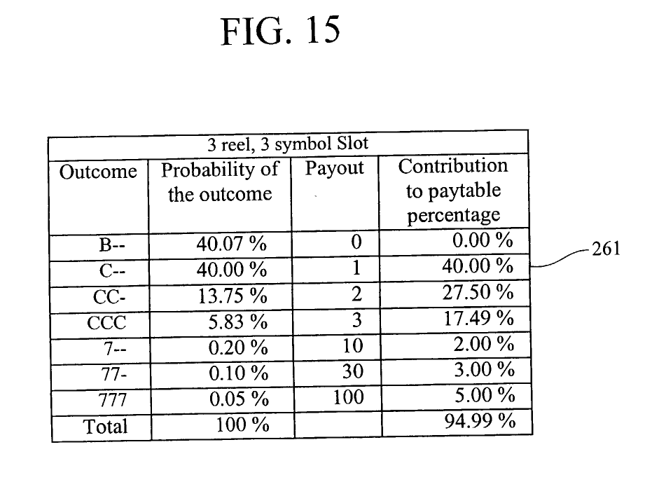

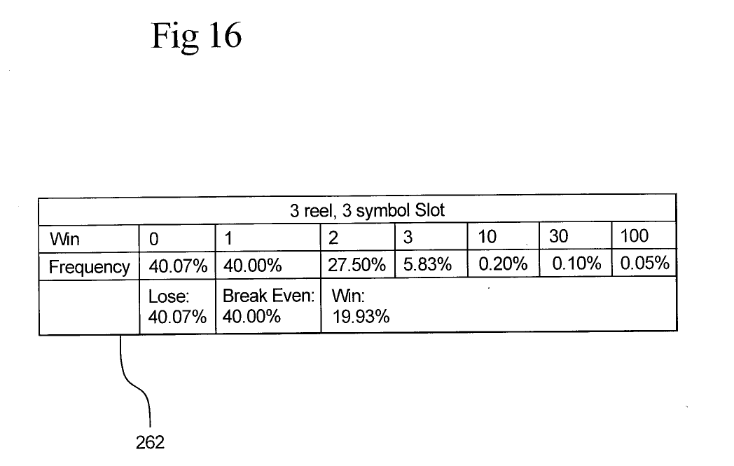

In another embodiment, the method of the present invention is used in a slot game. In the keno example, the outcomes were grouped into 11 classes, i.e., (“Hit 0” to “Hit 10”). In the slot example, each possible outcome is an individual entry in the paytable. The slot game has three reels with 3 symbols per reel: a Blank, a Cherry and a Seven. With respect to the outcomes, “B” denotes a Blank, “C” denotes a Cherry and “7” denotes a Seven. A dash denotes any suitable symbol. This is shown in table 260 in FIG. 14. The outcomes are assigned payouts and probabilities, as shown in table 261 in FIG. 15. The corresponding distribution table 262 is shown in FIG. 16.

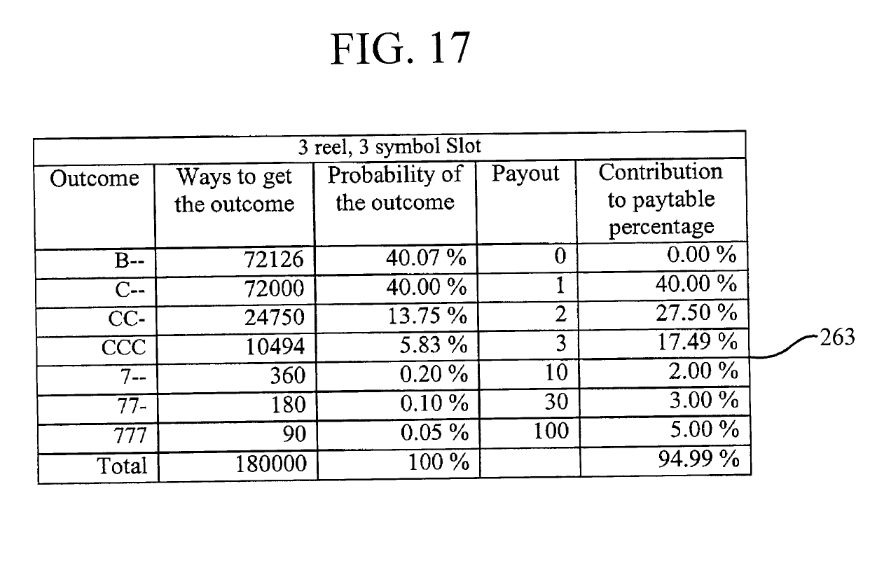

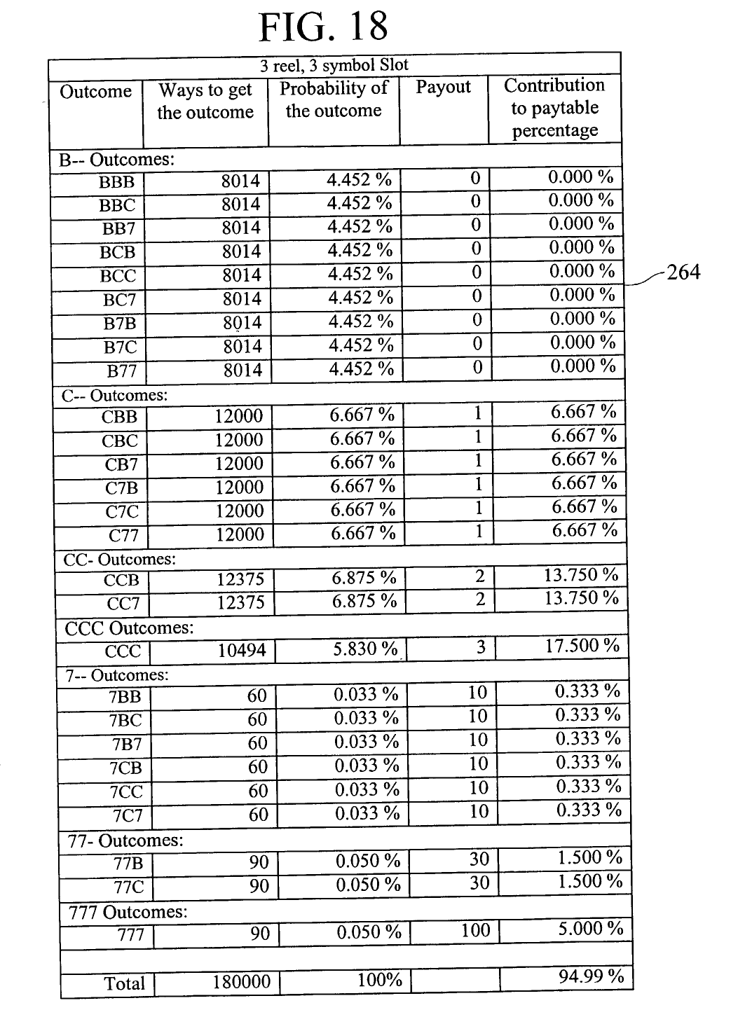

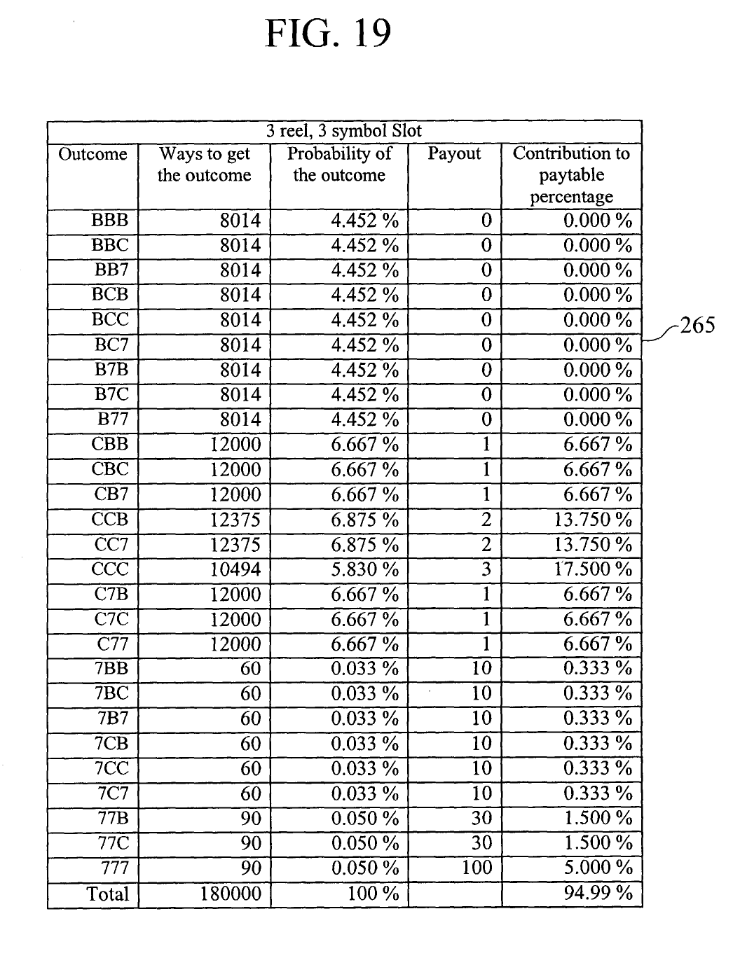

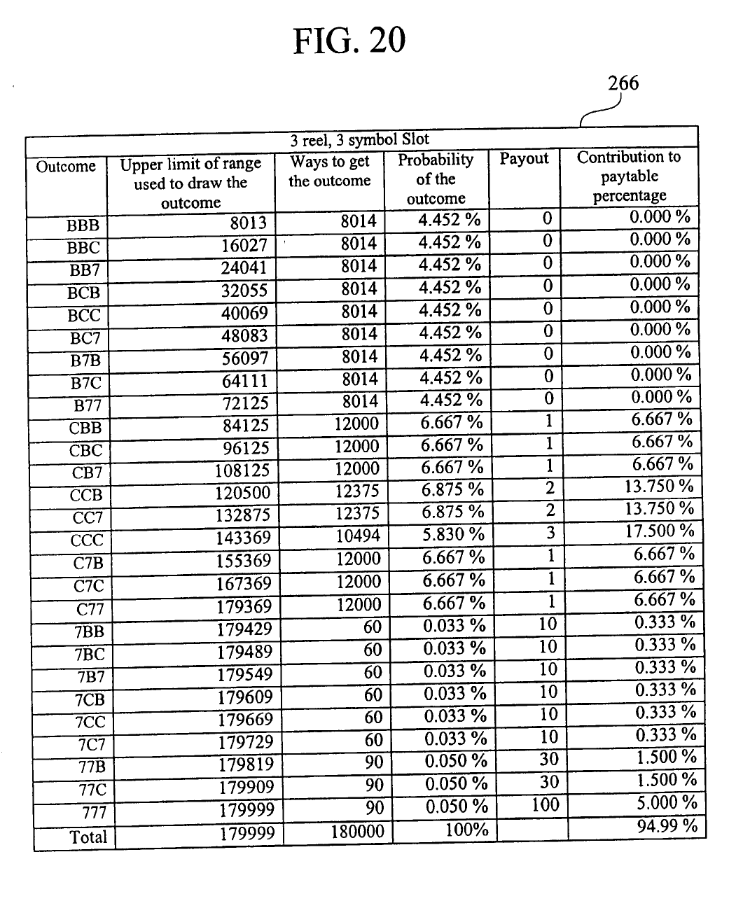

Each type of win is classified into an outcome. The outcomes are assigned a range of numbers. For purposes of this example, numbers that can be easily divided by the number of possible outcomes are chosen. Each type of win with 1 dash has 2 or 3 possible outcomes and each type of win with 2 dashes has 6 or 9 possible outcomes. A number that is divisible by 18 is chosen. Also for purposes of this example, a range is desired that can be multiplied by the smallest probability (0.0005) to produce an integer. A range that is divisible by 10,000 is desired. Thus, the selected range is 180,000. FIG. 17 displays table 263 which has various outcome data. Each type of outcome is classified into individual results, as shown in a table in FIG. 18. Next, the outcomes are sorted in an order enabling conversion of each game into a unique number, as shown in table 265 in FIG. 19. The outcomes are then assigned ranges and the upper limit of each range is stored, as shown in table 266 in FIG. 20.

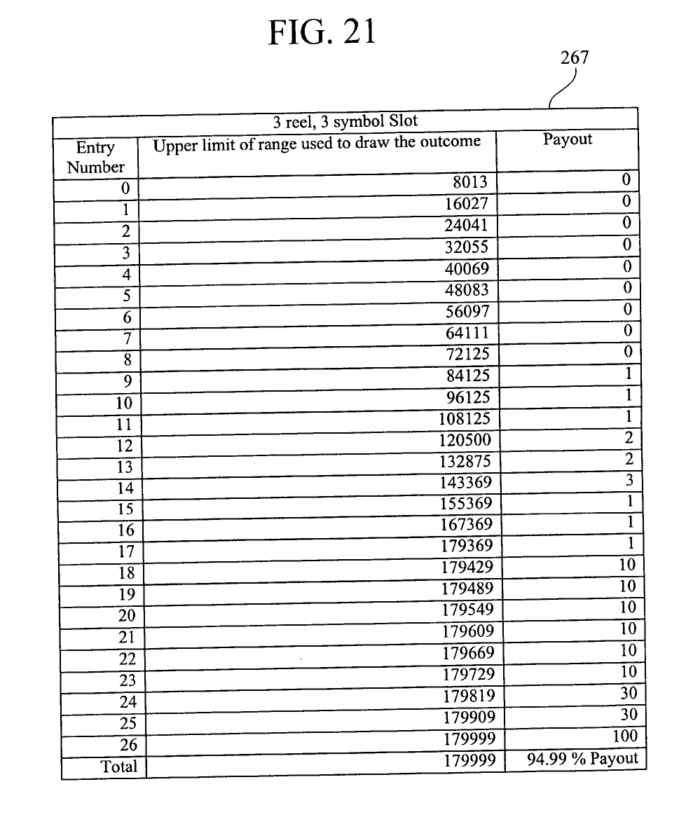

The gaming device can then draw a number correlating to a specific result, as described in the previous examples. In one embodiment, only the necessary information is kept in the finished paytable. An entry number in the paytable is the number that is converted to a game. Thus, the gaming device stores only the upper limits of the ranges and the payout. The entry number is shown for purposes of this example in table 267 of FIG. 21, but is not actually stored in the finished paytable.

Using this method, a random number is drawn in the range indicated by the paytable (0 to 179999). The paytable entry is selected which has the lowest range upper limit that is greater than or equal to the random number drawn. For example, if 123,456 is chosen, entry 13 is selected. Various different suitable methods could be employed to determine this number. One such method is described in co-pending commonly owned U.S. patent application Ser. No. 10/066,496, filed Dec. 5, 2001 entitled Method For Representing A Game As A Unique Number, which is incorporated by reference in its entirety herein. The entry number, 13, is converted to a game outcome. In this example, the result is CC7, or a cherry on each of the first and second reels and a “7” on the third reel. When the game ends, the payout amount indicated by entry 13 in the paytable, which is 2, is paid to the player.

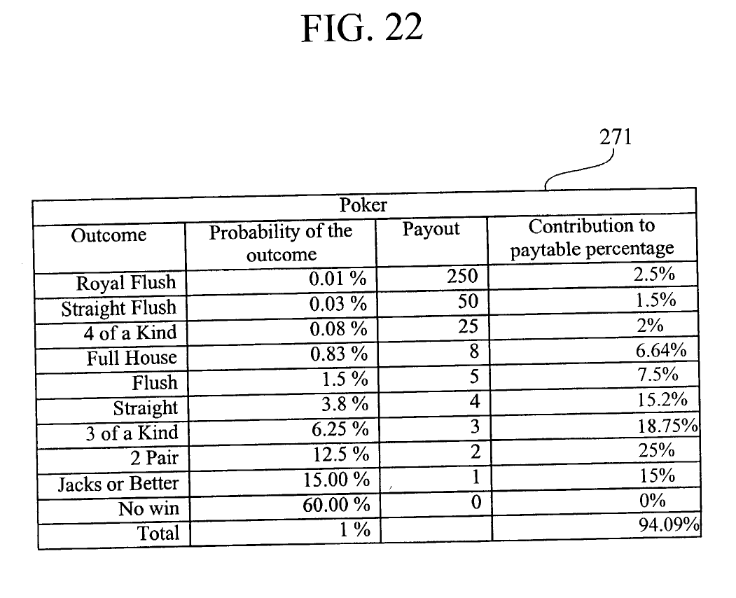

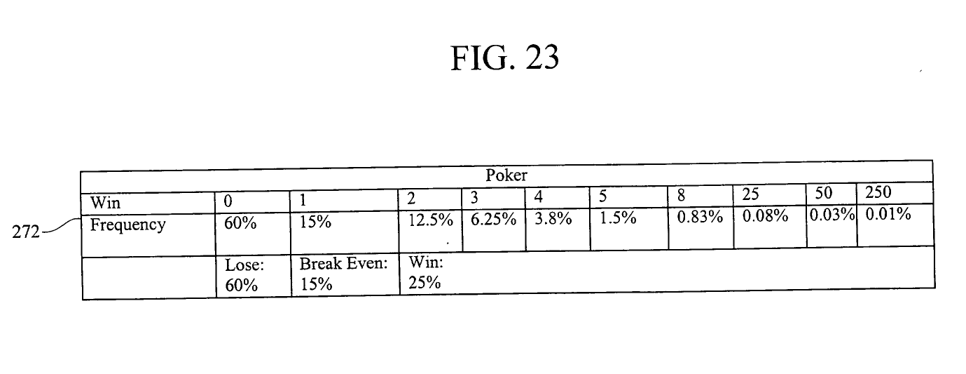

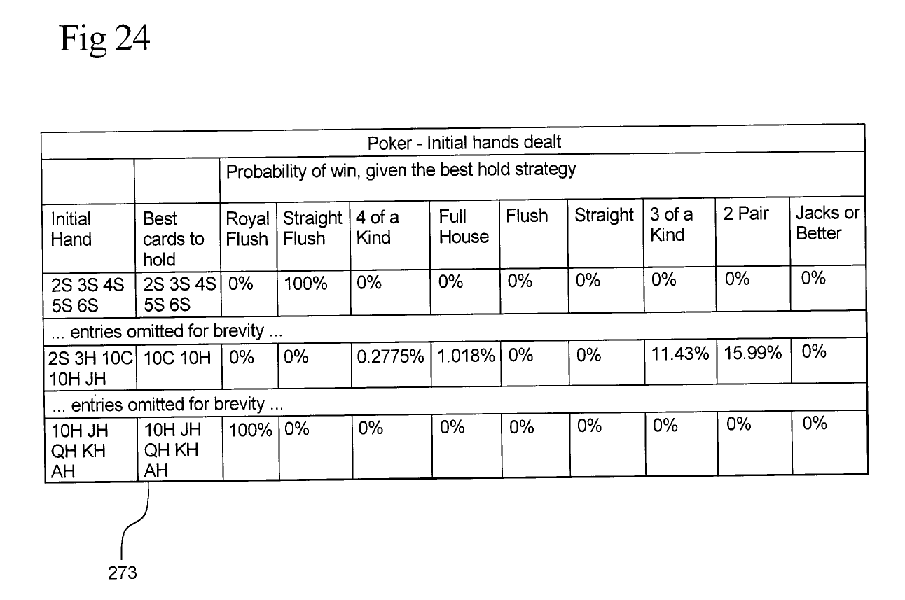

In another example, the method is applied to poker games. First, a paytable and distribution of outcomes is generated in table 271 in FIG. 22. The corresponding distribution table is 272 shown in FIG. 23. A list of all possible hands is generated. For each hand, the probability of drawing each win is computed. It is assumed that the player makes the best decisions as to what to hold. The table contains 2,598,960 entries for a simple, 52 card single-deck, no joker or wild card poker game. In a hand notation table 273 shown in FIG. 24, each card is represented by a face value such as 2, 3, 4, 5, 6, 7, 8, 9, 10, Jack, Queen, King, and Ace, and a suit such as diamonds, hearts, clubs or spades.

Each initial hand dealt is assigned a probability. Each hand's contribution to the probability of getting each win is computed by multiplying the probability of that hand being drawn by the probability of getting the win, given that the player uses the best hold strategy. The sum of all initial hands' contributions to the probability of getting a win must add up to that win's probability, as defined in the distribution table. It should be appreciated that there is a wide degree of latitude in setting the probabilities of the initial hands. There are 2,598,960 probabilities to set and 10 totals which result.

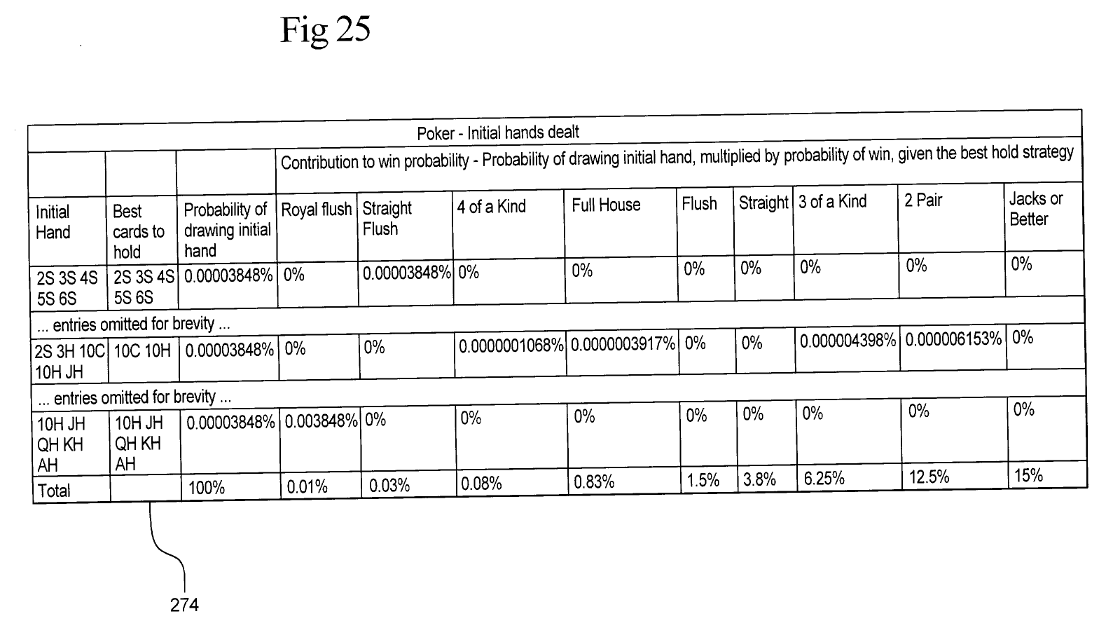

The preferred method is to use a suitable program which will start with all hand probabilities being equal and make incremental changes to a small number of hands at a time to produce the desired totals. It is desirable to have the hands' probabilities still very close to one another, so that no single hand is noticeably more frequent or rare than the average. Table 274 in FIG. 25 displays the results for initial hands.

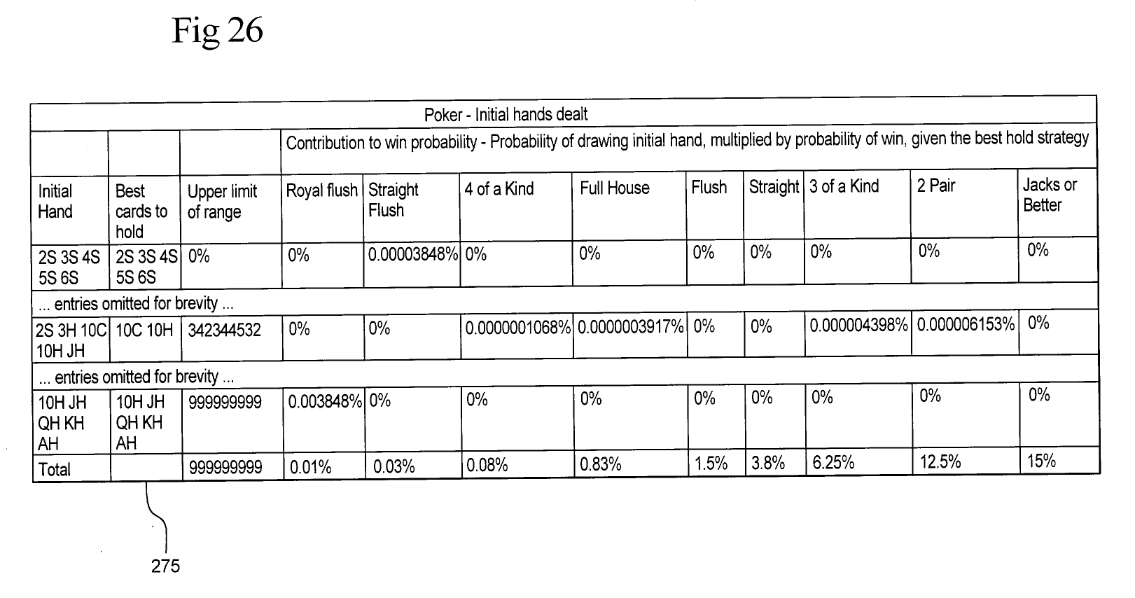

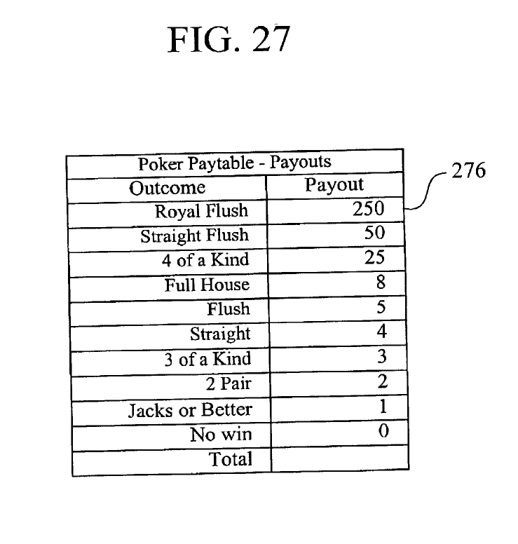

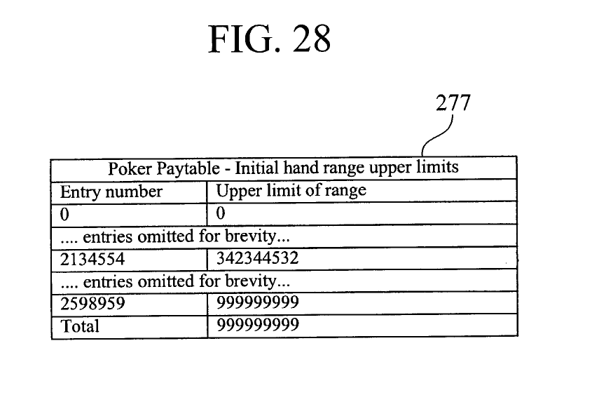

The probabilities are converted to ranges by the same method used in the keno and slot examples described above. The upper limit of each range is stored in the memory device. Arbitrary values for this example are shown in table 275 in FIG. 26. The finished paytable stores the payouts for winning hands and a list of upper limits of ranges for initial hands. The entry number is shown for purposes of this example, but is not actually stored in the finished paytable which is shown in FIG. 27. An example of the ranges is provided in table 277 in FIG. 28.

To use the method, a random number is drawn in the range indicated by the paytable. The entry in the paytable is found which contains the lowest upper limit greater than or equal to the random number. A binary search or other suitable methods may be implemented to perform this step. The entry number is used to produce an initial hand. The hand is dealt to the player who may then choose what cards to hold. When the player draws cards, the cards in the initial hand are considered by the processor to be removed from the deck. The remaining cards are randomly shuffled and the correct number of cards are drawn. The final hand is evaluated according to the payouts and the win, if any, is awarded.

### Methods of Producing Outcomes and Results

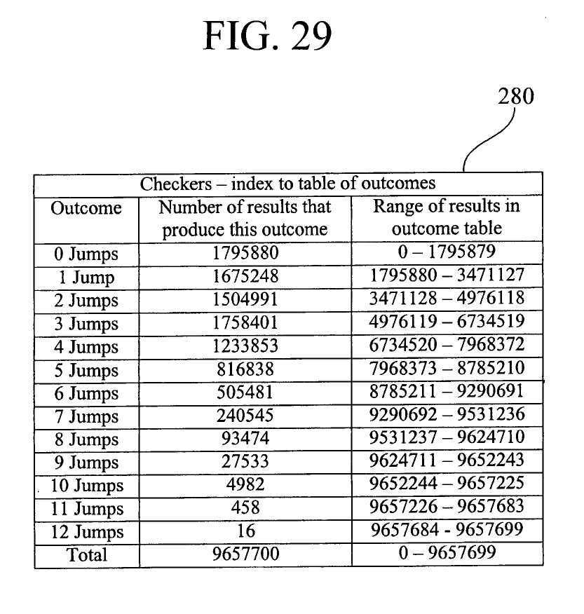

One method of producing outcomes employing the present invention is by creating a table containing all possible games, sorted by outcome. The specific implementation of the table could also incorporate data compression methods that reduce the amount of storage required in a processor. In one example, the method is utilized for a checkers game having 9,657,700 possible results. Each result is converted into a number so that each result can be stored as a number from 0 to 9,657,699. The table stores every possible game, ordered by the number of jumps possible. An index 280, such as that in FIG. 29, indicates the starting number position and range for each outcome.

Thus, if the gaming device determined that a 3-jump outcome should be produced, the gaming device would draw a random number from 0 to 1758400, the number of 3-jumps games that exist. The gaming device would then add that number to the starting range of the 3-jump boards, 4,976,119. This correlates to a 3-jump result in the table of outcomes. The gaming device verifies the number in the table and applies an algorithm to convert the number into a 3-jump game. The gaming device then produces the result.

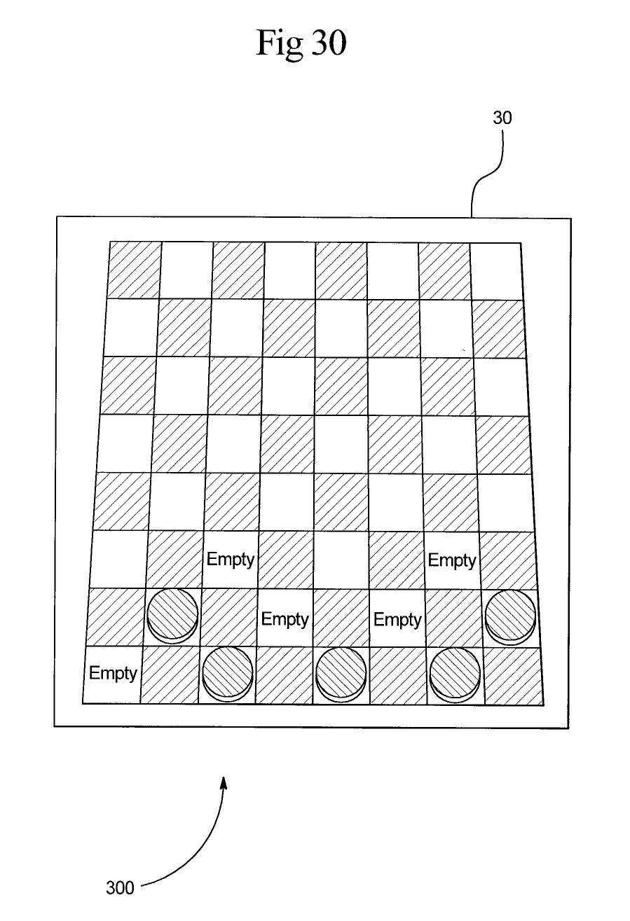

Another method of producing outcomes is by using an outcome template. The template may store a pattern to follow in order to generate a certain outcome. An example of a template for generating a 0-Jump board 300 in checkers is shown in FIG. 30. A total of 9 templates can be used to represent all 0-Jump checker games. In the template, the spots marked “Empty” are required to be empty. The 12 black pieces are distributed randomly on the other 22 squares. This template represents 646,646 possible boards and can be stored in 8 bytes of memory.

Another method of producing outcomes is through the use of heuristics. For example, in keno, if it is known how many spots the player marked, and how many hits are required for the outcome desired, the gaming device can randomly coincide the necessary number of draws with the player's choices, then randomly distribute the remaining draws on empty spots. This method can also apply to slot games. If a certain outcome is desired, the gaming device can set reel positions to reflect that outcome.

In another method, the gaming device randomly draws results until it selects an outcome of the desired type. The results may be stored within the processor. This, however, may not be preferable due to time delays in searching for the result.

In another method, the outcomes could be generated using a combination of the above described methods of generating outcomes. For example, a gaming device providing a checkers game could store templates for 0, 1 or 2 jump boards. The gaming device could randomly draw a 3 or 4 jump board, and use a table of outcomes for 5-12 jump boards. The probability is such that the gaming device would only have to try 5-10 games to get a 3 or 4 jump outcome. For rare outcomes such as 5-12 jumps, the gaming device can examine a table of outcomes and draw an outcome. This combination of methods reduces time and memory required to produce the desired outcome.

Accordingly, it should be appreciated that the present invention provides certain advantages over the known methods of setting and using paytables. With the ability to control the probability of each outcome, it is possible to take an existing paytable that has proved to be popular and successful, and apply its probabilities to new paytables. In one example, a keno game may demonstrate the payout percentage of a slot game. In another example, a checkers game may imitate a keno paytable. Another advantage, is that different types of games can have the same odds for their top win, and thus, can be connected to the same progressive jackpot. A further advantage is that paytables can be set such that the games have both high wins and an increased frequency of low wins, as opposed to certain known paytables that prevent the combination of these win types.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims, and this application is limited only by the scope of the claims.

The invention is claimed as follows:

1. A gaming device comprising:
a processor;
a memory device accessible by the processor;
a game; and
a plurality of different results in the game, said different results classified into a plurality of sets of different results, wherein: (a) the results in each set of results produces a same outcome, (b) each of the results in each set of results is numbered, (c) the outcomes and the numbered results are stored in the memory device, and (d) the processor randomly selects the results in the game from the plurality of results by randomly selecting one of the outcomes from all of the outcomes and then selecting one of the numbered results in said set of results which produce that outcome.

2. The gaming device of claim 1, which includes a display device controlled by the processor which displays the randomly selected result and outcome.

3. The gaming device of claim 1, wherein a plurality of the outcomes are awards.

4. The gaming device of claim 1, wherein one of the outcomes is no award.

5. The gaming device of claim 1, wherein at least one of the outcomes is a jackpot award.

6. The gaming device of claim 1, wherein the results are consecutively numbered.

7. The gaming device of claim 6, wherein the processor randomly selects one of the consecutive numbers associated with the results.

8. A method for setting a paytable in a gaming device, the method comprising the steps of:
(a) determining a plurality of results;
(b) classifying the plurality of results into a plurality of sets of results, wherein all of the results in each set of results produces a same outcome; and
(c) numbering each of the results in the sets of results.

9. The method of claim 8, which includes the step of consecutively numbering the results in the sets of results.

10. The method of claim 8, which includes the step of creating a table containing the plurality of results, the classifications and the numbers associated with each result and storing said table in a memory device.

11. The method of claim 10, wherein the sets of results are stored as a template.

12. The method of claim 8, which includes the step of maintaining a payout history of the outcomes provided to players of the gaming device.

13. The method of claim 8, which includes the step of setting a numerical range for each of the sets of results.

14. The method of claim 8, which includes the step of setting an upper numerical limit for the results in each of the sets of results.

15. A method for producing a result in a game of a gaming device including a plurality of different results in the game, said different results classified into a plurality of sets of results, wherein all the results in each set of results produces a same outcome associated with said set of results and each of the results in each set of results is numbered, the method comprising the steps of:
(a) randomly determining one of the outcomes;
(b) selecting a number associated with one of the results in the set of results associated with said randomly selected outcome; and
(c) producing the result associated with the selected number.

16. The method of claim 15, which includes randomly selecting the number.

17. The method of claim 15, which includes providing any award associated with the outcome to a player.

18. The method of claim 15, including the step of locating the result in the set of results based on the upper limit for each set of outcomes.

19. A method of replicating an existing paytable of a first gaming device for a second gaming device, the method comprising the steps of:
(a) determining all possible results of the first gaming device and the different outcomes associated with each of the results;
(b) classifying the results into sets of results, wherein each result is classified in the set of results with the associated outcome provided by said result;
(c) assigning a number to each of the results in each of the sets of results; and
(d) storing the numbers, results and the outcomes into a memory device for the second gaming device.

20. The method of claim 19, wherein the duplicated paytable is used for a different type of game.

21. The method of claim 19, wherein the duplicated paytable is used for the same type of game.
